(19) United States
(12) Patent Application Publication
(10) Pub. No.: US 2019/0201779 A1
(43) Pub. Date: Jul. 4, 2019

(54) App integrated wearable gaming board design

(71) Applicants: Keith Vargo, Roswell, GA (US); Vargo Consultants, Roswell, GA (US)

(72) Inventors: Keith Vargo, Roswell, GA (US); Vargo Consultants, Roswell, GA (US)

(21) Appl. No.: 15/988,494

(22) Filed: May 24, 2018

Related U.S. Application Data
(60) Provisional application No. 62/610,960, filed on Dec. 28, 2017.

(51) Int. Cl. A63F 3/04; G09B 19/22; A41B 1/08; G09B 7/10; G09B 7/02; A63F 3/00; G09B 5/02

(52) U.S. Cl. CPC A63F 3/04; G09B 19/22; A41B 1/08; G09B 7/10; A63F 2250/166; A63F 3/00643; A63F 3/0023; G09B 5/02; A63F 2003/00258; G09B 7/02

(57) ABSTRACT

A sophisticated and innovative technology to develop an interactive communication system whereby a participant/child accrues learning ability by selecting at least one possible outcome of a plurality of outcomes via touching or interacting with clothing (embodied with the game board) that results in developing and enhancing various basic learning skills and comprehension, e.g., finding certain elements or content; tracing various paths or designs; repeating works/letters/objects found on the designs; or combining various ideas and concepts found on the designs. The outcome can be entered manually, through sensors, wirelessly, or via Wi-Fi enabled means, that can be detected and recorded by the application to develop results, scores both individually and against normative databases, and progression trends of the learning child.

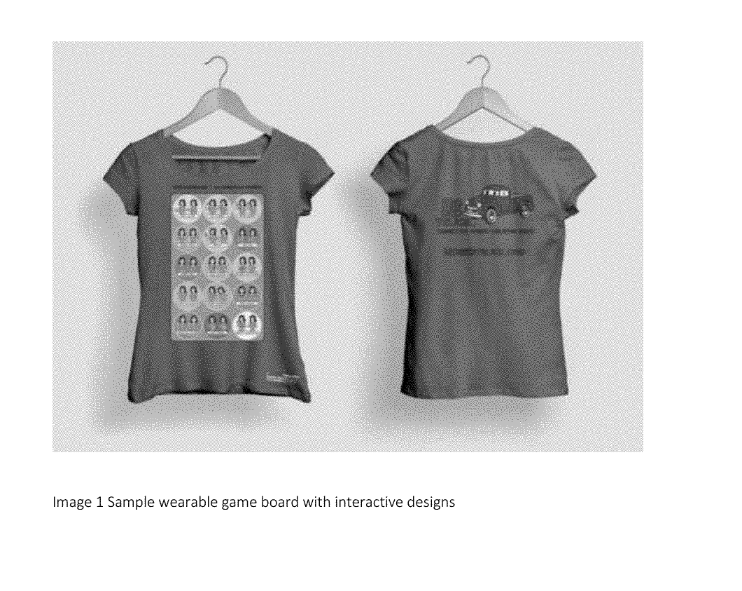

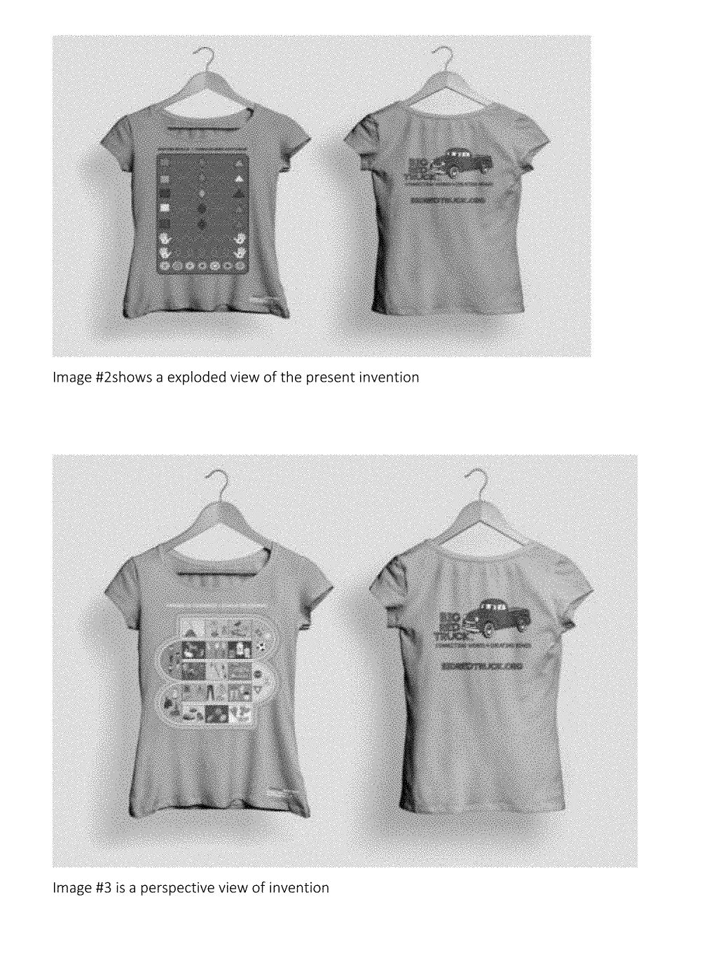

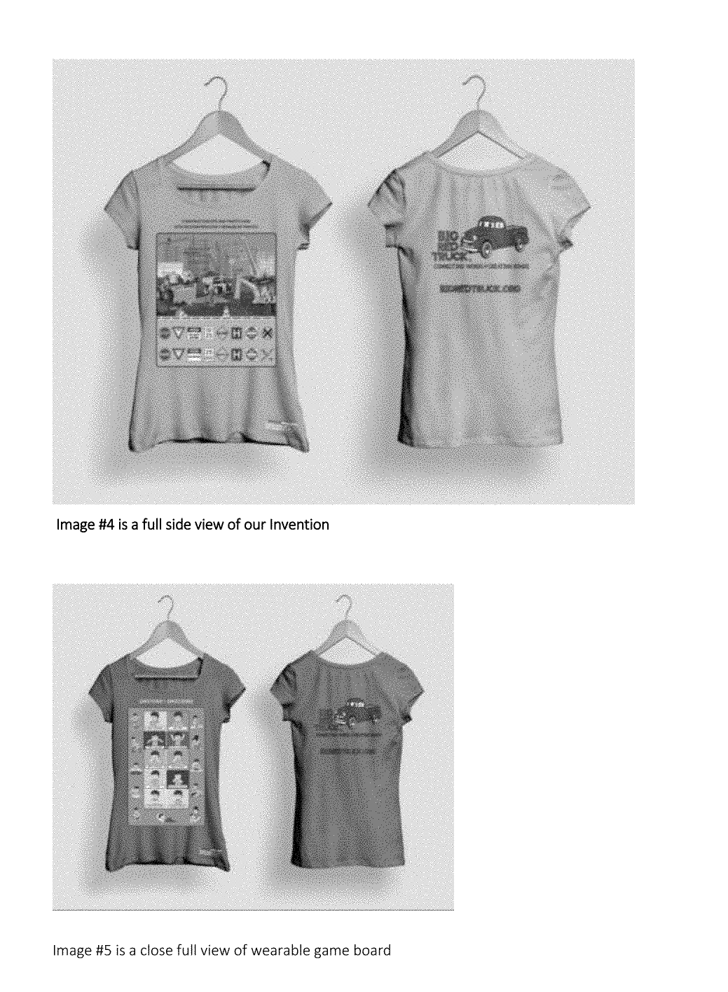

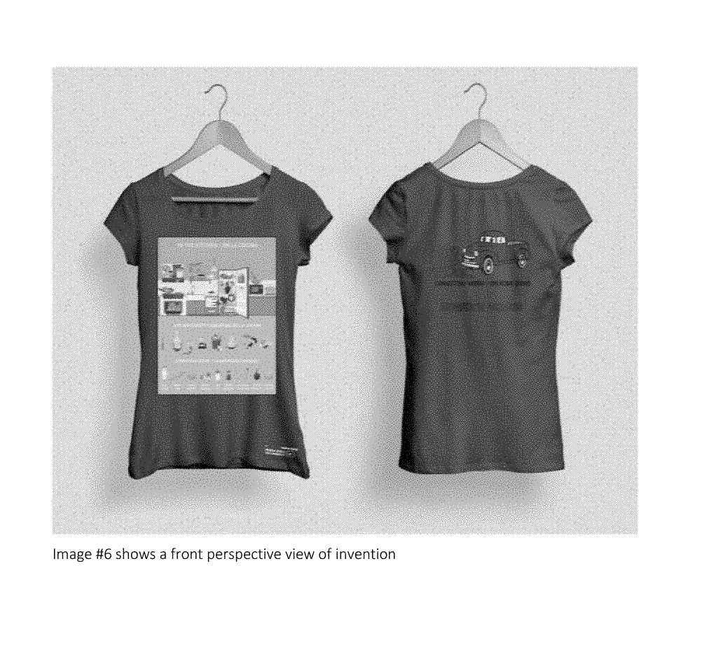

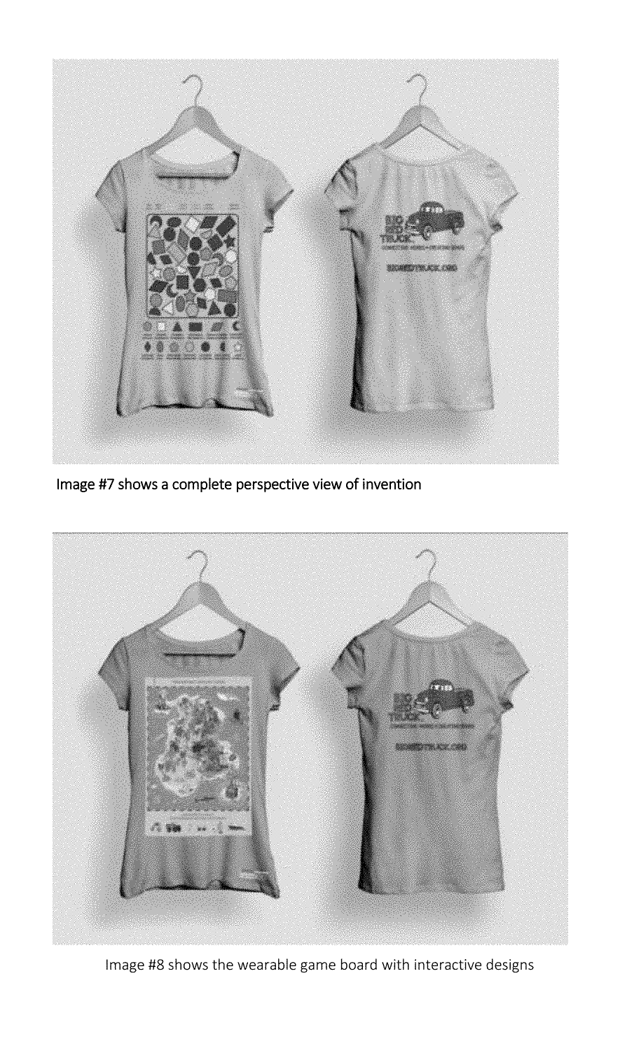

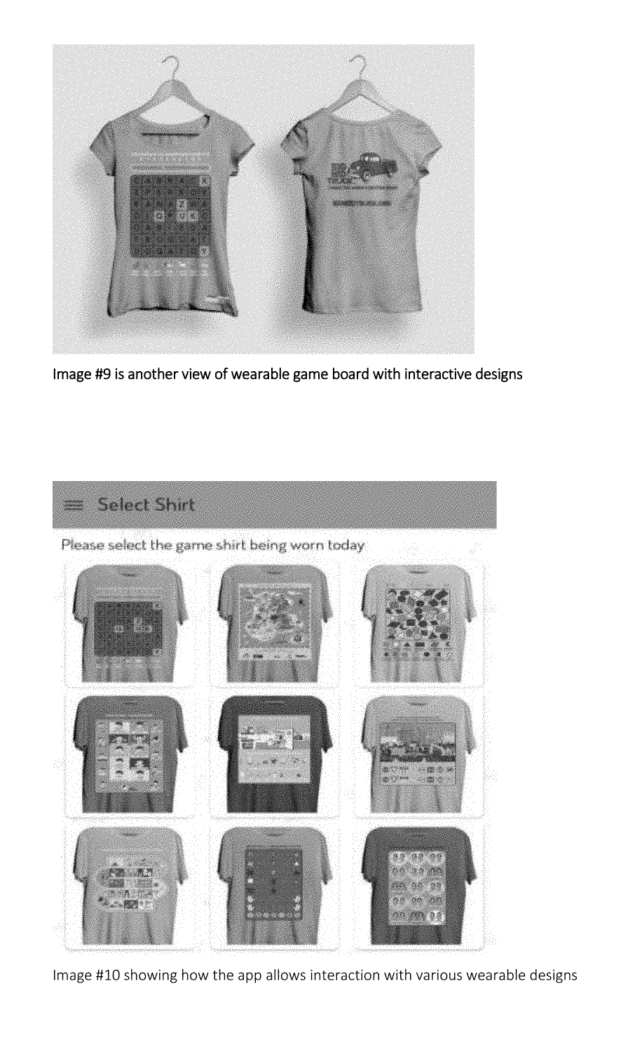

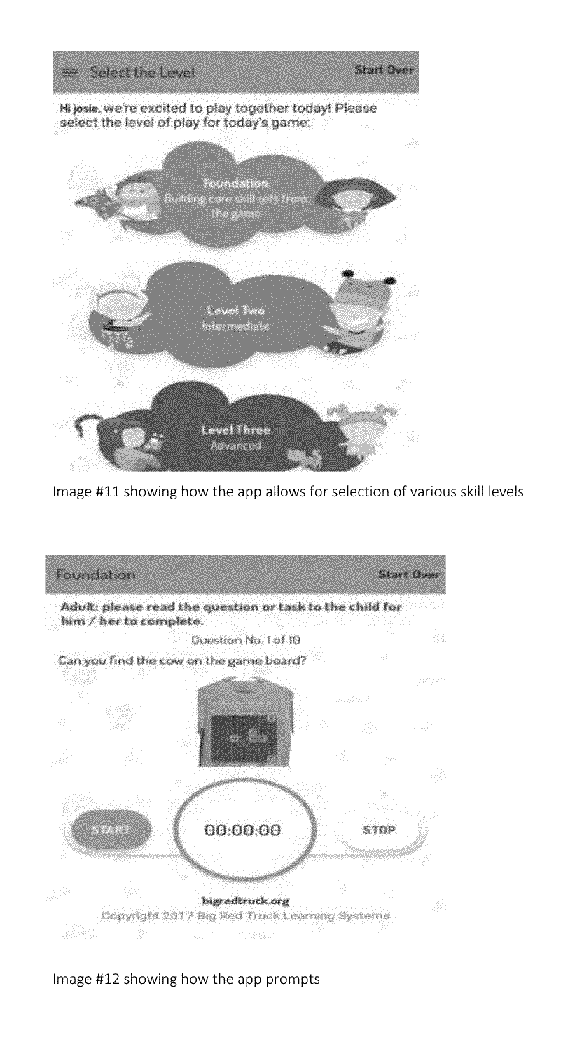

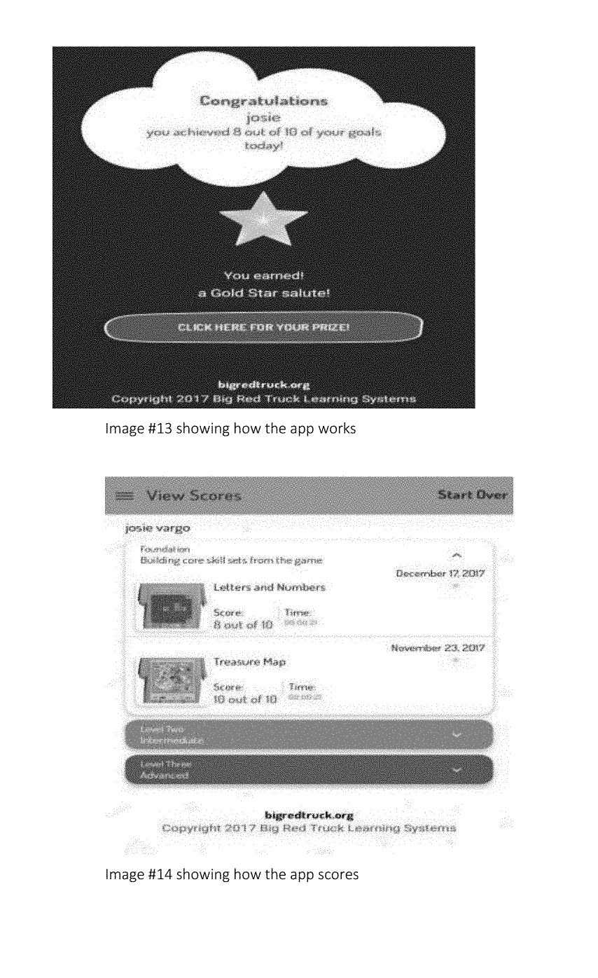

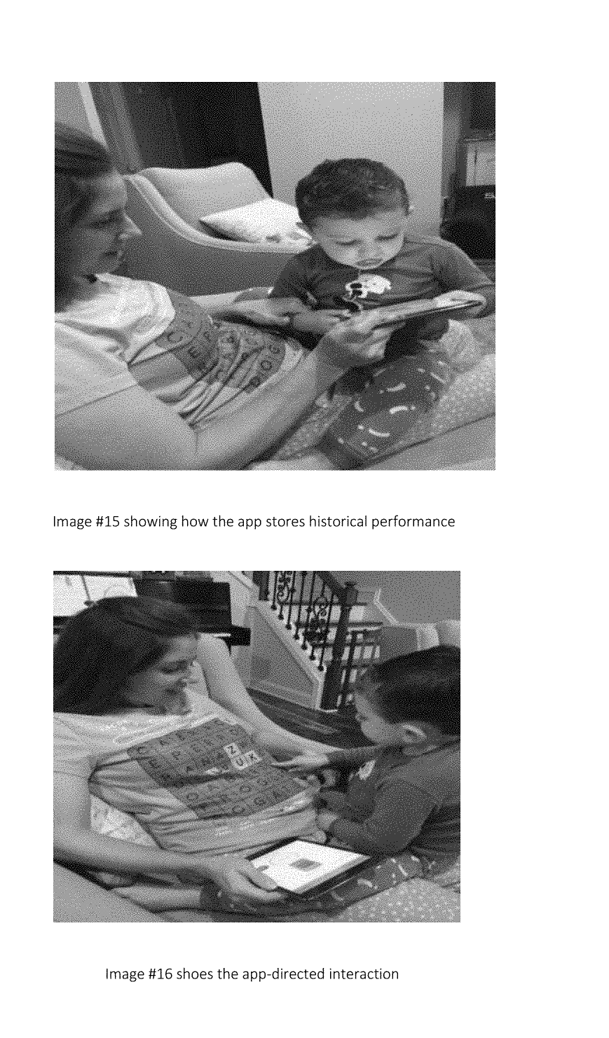

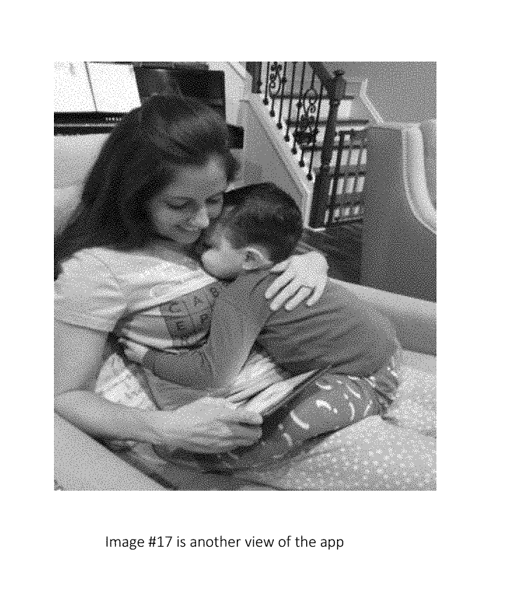

### CROSS-REFERENCE TO RELATED APPLICATION

This application is a Continuation application that claims the benefit, under 35 U.S.C. 120, of U.S. application Ser. No. 62/610,960, filed on 28 Dec. 2017 the contents of which are herein incorporated by reference in its entirety.

### BACKGROUND

### Field of the Invention

The present invention relates to a wearable interactive gaming platform integrated with a downloadable app. The app is generally used as a part of an integrated learning/gaming system, which enables the completion of tasks by answering questions that are on the game board design, which is being worn by one of the participants. Moreover, the wearable gaming board may be controlled biomechanically, via sensors or other Wi-Fi enabled means, and interacted with on a physical basis by one of the participants.

### Description of the Related Art

The importance of introducing and developing early stage learning skills; for example, learning phonetics, number/letter/color skills, basic object identification, emotion recognition, sign language, and other social skills amongst young children, are critically important to early child development. There are many educational toys/games that attempt to engage a child's interest and to teach the child any of a variety of concepts by virtue of the child's play with it. However, for children and teenagers today, the current trend of many games is towards more video and app based games that often isolate the child and distract the child from interacting with other children or adults. Furthermore, there is a growing feeling of restraint & lack engagement with other individuals, particularly adults and the child's peers. The wearable gaming platform is meant to redirect that alone screen time for children and increase their physical social interaction with others. The gaming system can be worn by an adult/participant with provisions for other applications via remote sources. The gaming system also encourages physical activity and interaction as a part of the app initiated experience. For many children, in particular those with developmental disabilities and autism, touching or physically engaging with others is a challenge. This gaming system creates a fun environment that encourages physical interaction between participants to help build environments of trust to serve a basis for other interaction and intervention. In addition, the gaming system is able to store all historical game performance and trends for each participant/child to better assist parents/educators/therapists in constructing customized learning programs for individual participants/children.

As mobile devices such as smart phones, tablets, smart watches and netbooks are used regularly by a significant percentage of the world's population, such mobile devices become even more important and impactful to children, and provide a platform to deploy innovative educational games.

It is thus pertinent that integrating the wearable game board with a mobile device can lead to widespread and effective utilization of such a system and specifically intended for the young children.

There are a number of patents having such integrated gaming platforms are in existence, a comprehensive survey of these patents revealed the following:

A U.S. Pat. No. 2,005,0113,167 issued to Sony Deutschland GmbH depicts physical feedback system for computer gaming environments comprises:

A computing device for executing an application software program, the computing device having an interface for transmitting feedback signals generated by the application software program, and a wearable receiver having means for receiving the feedback signals from the computing device and actuator means designed to enter physical feedback sensations to the body and/or head of a user using the skin of the user as an interface.

A Video-game console for allied touchscreen media having U.S. Pat. No. 2,016,003,083,5 issued to Chris Argiro depicts the present invention which seeks to introduce a new delivery system, interactive platform and controller compliment for an allied touchscreen media; with said media particularly comprising repository-sourced mobile game applications configured for native operation. Mapping systems are dynamic and include an interface for user manipulation of immersive, 3-D holographic imaging modalities to advance input in a video-game environment. A series of specialty-input controllers for interaction with said touchscreen media are also advanced by the inventor; including those designed for remote and mappable manipulation of an actionable sensor input where salient to the input dynamics of an engaged gaming title. A user worn artificial muscle interface that reacts to game events are also advanced by the inventor.

A Disney Enterprises Inc embodying a wearable garments recognition and integration with an interactive gaming system having U.S. Pat. No. 2,017,036,122,5. It depicts systems, methods and articles of manufacture for managing a wearable garment device. Embodiments include determining an identification credential that uniquely identifies a player within an interactive gaming environment. A gameplay state of the player within the interactive gaming environment is retrieved. The gameplay state includes at least one of a rank of the player, one or more accomplishments of the player and a group to which the player belongs within the interactive gaming environment. Embodiments determine a wearable garment device having a preexisting association with the player within the interactive gaming environment. The wearable garment device is configured with one or more display devices. A graphical depiction of at least a portion of the gameplay state is generated and embodiments cause the generated graphical depiction to be output for display using the one or more display devices of the wearable garment device.

EP 1533678 A1 talks of a physical feedback system for computer gaming environments comprising of a computing device for executing an application software program, the computing device having an interface for transmitting feedback signals generated by the application software program, and a wearable receiver having means for receiving the feedback signals from the computing device and actuator means designed to enter physical feedback sensations to the body and/or head of a user using the skin of the user as an interface.

A U.S. Pat. No. 2,012,019,046,0 issued to THEM THEY LLC depicts a video game console accessory providing a vest with sensory feedback rumblers at various positions on a vest. The game console may now provide sensory feedback to the game player by coordinating what occurs visually in the game with a physical sensation experienced by the game player. The rumblers are positioned against the gamer's torso to provide dynamic sensations to increase realism experienced during game play. Each rumbler is independently controlled. An optional feature is the availability of various skins to alter the appearance of the device and to match a particular theme of the game played.

The invention Sound touch type game vest bearing Canadian Patent CN105833523A discloses a sound touch type game vest. The sound touch type game vest comprises a front part, a rear part and a sensor. The upper end of the front part and the upper end of the rear part are fixedly connected through connecting belts. The lower end of the front part and the lower end of the rear part are fixedly connected through adjusting belts. The sensor is arranged at the position, relative to the thoracic cavity of the human body, in the front part. A storage box is arranged at the front end of the front part. A single-chip microcomputer, a power source, an A/D converter and a data acquisition unit are arranged in the storage box. According to the sound touch type game vest, the sensor is arranged in the front part of the vest, the vest is convenient to wear, the sensor makes accurate contact with the special position of the thoracic cavity of a user, the user feels impact shock, meanwhile, through the resonance effect of the thoracic cavity of the human body, the user can acquire sound compensation at rich frequency acoustically, and a higher site stereoscopic effect is acquired. Virtual reality world experience is provided for the user, practicality is high, and use and popularization are easy.

A U.S. Pat. No. 2,005,025,058,2 issued to Miguel Lopez depicts a vest that is worn while playing a video game is in the shape of a bandoleer and has a multiplicity of tactile signal-producing elements thereon. The tactile-signal producing elements are located all around the player so the player will receive tactile signals from all directions and the signals can be received simultaneously so action in the video game will be accurately and realistically reproduced in the form of tactile signals.

Another utility model discloses an electronic game waistcoat bearing patent # CN2782177Y, which comprises a control unit with a plurality of output ports, a vibration unit, a power unit used for supplying power for the control unit and the vibration unit, and a waistcoat. The control unit is used for outputting drive signals on corresponding output ports according to play shoot signals of game equipment. The vibration unit comprises at least one vibrator, and the input end of the vibrator is connected with the output ports of the corresponding control unit. The vibration unit generates the vibration after receiving the drive signals of the output ports. The waistcoat is used for placing the control unit, the vibration unit and the power unit. When the utility model is worn to play games and one part of the body is shot by opponents, the game data transferred to electronic game waistcoat drives the vibrator after treatment, and vibration with certain intensity is timely sent out on corresponding part arranged on the electronic game waistcoat. The game player has real game experience, and the authenticity, entertainment and interests of antagonism games are raised.

A U.S. Pat. No. 2,015,010,512,9 issued to Kevin Chapman is a video game body suit for use when playing a video game. The video game body suit includes a torso covering, leg coverings, arm coverings, and a headset. Each of the components includes one or more feedback devices thereon, wherein the feedback device may include one or more of a vibration motor, a speaker, a temperature-controlling device, and a scent-emitting device. The headset comprises a headband, an earpiece, and a microphone thereon for allowing the user to remotely communicate with other players. The body suit further includes a control circuit that includes a microprocessor and a transceiver capable of wirelessly communicating with a video game console and the various feedback devices. In this way, the video game body suit can provide feedback to the user corresponding to the events that occur within the game.

A U.S. Pat. No. 2,018,008,567,3 issued to Ole Birkedal is Vest and Motion Sensitive Wand for Interactive Game Play depicts an interactive magical themed game played by one or more players. Each player is equipped with a motion sensitive wand, capable of casting infrared spells, a vest, capable of receiving infrared spells, and a smartphone, capable of displaying scores and creating user profiles. Vest, wand, and smartphone are connected and equipped with Bluetooth technology. All Bluetooth connections are facilitated by a smartphone app. The app also stores and accesses user information in an online server. The game enables players to win points by casting spells at opponents and defending themselves from the spells of opposing players.

A video game body suit issued to Kevin Chapman bearing U.S. Pat. No. 2,015,010,512,9 for use when playing a video game. The video game body suit includes a torso covering, leg coverings, arm coverings, and a headset. Each of the components includes one or more feedback devices thereon, wherein the feedback device may include one or more of a vibration motor, a speaker, a temperature controlling device, and a scent emitting device. The headset comprises a headband, an earpiece, and a microphone thereon for allowing the user to remotely communicate with other players. The body suit further includes a control circuit that includes a microprocessor and a transceiver capable of wirelessly communicating with a video game console and the various feedback devices. In this way, the video game body suit can provide feedback to the user corresponding to the events that occur within the game.

A U.S. Pat. No. 7,967,679 B2 talks of a tactile garment, such as a gaming vest or other garment or body-enveloping device. A pneumatic forcegenerating device is embedded in the vest in multiple cell zones for selectively applying a modulated force to a user wearing the multi-layered vest. A compressed air source comprising a compressor and an associated canister selectively actuates the pneumatic forcegenerating devices to produce a tactile response. A control valve assembly couples the pneumatic forcegenerating device to the compressed air source. A controller selectively opens and closes the control valve to modulate the pneumatic forcegenerating device and generate forces simulating real forces, such as impact and Gforces. Force sensors may be deployed in the cell zones to provide force data for generating secondary forces.

A U.S. Pat. No. 2,017,019,249,4 A1 relates to a wearable interactive gaming device and a method for enabling interactive gaming. The wearable interactive gaming device includes at least one wearable unit wearable on a player. The at least one wearable unit includes a display unit, a motion sensor unit, a communication unit, and a receiver unit. The display unit enables setting up of a game and indicates parameters in the game. The motion sensor unit senses gestures performed by the player. The communication unit communicates interactions with one of at least one robot device and at least one wearable interactive gaming device using mesh network. The communication unit includes a hardware interface unit that allows attachment of controller units in accordance with the game. The receiver unit receives the interactions from at least one competing player. The wearable interactive gaming device operates on a gaming platform that is used by developers for publishing games.

A U.S. Pat. No. 9,282,893 B2 discusses a wearable communications garment that includes one or more user-selectable inputs integrated into the garment. A sartorial communications apparatus may include a flexible material that is worn (e.g., as an undergarment) by the user and includes one or more interactive sensors that may be manually activated by a user, even through one or more intervening layers of clothing. The apparatus may also include one or more additional body sensors configured to sense a user's position, movement, and/or physiological status. The sensor(s) may be connected via a conductive trace on the garment to a sensor module for analysis and/or transmission. Methods of manufacturing the garments as well as methods of using the garments are also described.

A U.S. Pat. No. 2,007,010,562,6 issued to Nintendo Co Ltd is a systems and methods involve a video game system that has a touch sensitive display screen that can be used to supply inputs used in video game control. In one example system and method, a user or player draws movement patterns on the touch sensitive display screen. The drawn movement patterns are stored and a game object can be moved in accordance with a drawn movement pattern selected from the memory by the user.

A Magical wand and interactive play experience having U.S. Pat. No. 7,445,550 issued to Creative Kingdoms LLC is the invention provides a unique interactive play experience carried out utilizing a toy “wand” and/or other actuation/tracking device. In one embodiment, the wand incorporates a wireless transmitter and motion-sensitive circuitry adapted to actuate the transmitter in response to particular learned wand motions. The wand allows play participants to electronically and “magically” interact with their surrounding play environment simply by pointing, touching and/or using their wands in a particular manner to achieve desired goals or produce desired effects. Various wireless receivers or actuators are distributed throughout the play facility to support such wireless interaction and to facilitate full immersion in a fantasy experience in which participants can enjoy the realistic illusion of practicing, performing and mastering “real” magic.

An Exercise Gaming Device and Method of Facilitating User Exercise During Video Game Play bearing U.S. Pat. No. 2,008,014,633,6 is issued to IA Labs CA LLC. The present invention embodiments promote performance of exercise by users during a video or computer game by enabling a user to perform exercises to interact with the game. An embodiment of the present invention includes an exercise gaming device with a plurality of effector or gripping members in the form of handles to be manipulated by a user. The exercise gaming device further includes additional input devices to interact with a simulation or gaming scenario. The user applies forces to the handles to interact with the gaming scenario, thereby requiring the user to perform exercises during game play. The exercise gaming device may employ various damping mechanisms to provide resistance to the handles for the user. Alternatively, the handles may be fixedly attached to the exercise gaming device to resist the applied forces and provide isometric exercises for the user.

The utility model CN2,782,177 discloses an electronic game waistcoat which comprises a control unit with a plurality of output ports, a vibration unit, a power unit used for supplying power for the control unit and the vibration unit, and a waistcoat. The control unit is used for outputting drive signals on corresponding output ports according to play shoot signals of game equipment. The vibration unit comprises at least one vibrator, and the input end of the vibrator is connected with the output ports of the corresponding control unit. The vibration unit generates the vibration after receiving the drive signals of the output ports. The waistcoat is used for placing the control unit, the vibration unit and the power unit. When the utility model is worn to play games and one part of the body is shot by opponents, the game data transferred to electronic game waistcoat drives the vibrator after treatment, and vibration with certain intensity is timely sent out on corresponding part arranged on the electronic game waistcoat. The game player has real game experience, and the authenticity, entertainment and interests of antagonism games are raised.

Another present invention U.S. Pat. No. 2,008,014,633,6 issued to IA Labs CA LLC promotes performance of exercise by users during a video or computer game by enabling a user to perform exercises to interact with the game. An embodiment of the present invention includes an exercise gaming device with a plurality of effector or gripping members in the form of handles to be manipulated by a user. The exercise gaming device further includes additional input devices to interact with a simulation or gaming scenario. The user applies forces to the handles to interact with the gaming scenario, thereby requiring the user to perform exercises during game play. The exercise gaming device may employ various damping mechanisms to provide resistance to the handles for the user. Alternatively, the handles may be fixedly attached to the exercise gaming device to resist the applied forces and provide isometric exercises for the user.

A U.S. Pat. No. 2,002,010,302,4 issued to Hasbro Inc. is an Interactive gaming device capable of perceiving user movement. An interactive gaming device capable of perceiving user movement includes a controller connected to a display for providing user interaction with a game being played on the gaming device. The controller is further connected to a user input consisting of a light emitter and a light detector. The input may include a plurality of light emitters for emitting light at a plurality of locations and a single light detector for detecting light, or a single light emitter for emitting light, and a plurality of light detectors for detecting light at a plurality of locations, or a plurality of light emitters for emitting light at a plurality of locations, and a plurality of light detectors each being positioned in proximity to one of the plurality of light emitters for detecting light at a plurality of locations, or a game piece having a light emitter for emitting light, and a plurality of light detectors for detecting light at a plurality of locations. In each form, the controller polls the light detectors to see if user or game piece presence about that light emitter has caused the light emitted from the game piece to reflect to the polled light detector. If light has been reflected to the light detector, the controller is notified as such thereby allowing it to determine where the user is and where the user has moved.

A U.S. Pat. No. 4,925,189 issued to Braeunig Thomas depicts a video game controller which attaches to the user's upper body allowing the user to play a video game by leaning the upper body in any direction, simulating the movement of a joystick. The controller attaches to the user's upper back with an arrangement of straps and buckles. The tilt of the user's upper body is detected by an array of mercury switches with the resultant electrical signals being transmitted to the input of a video game. The specific angle of tilt required to actuate the mercury switches can be adjustable, thereby varying the degree of upper body movement needed to play a particular video game. Additional controls for the video game, such as a firing control, are provided by a hand-held pushbutton attached to the controller via a flexible cord. Playing a video game using this arrangement results in vigorous exercise of the abdominal, back and lateral muscles.

A Hasbro Inc. bearing U.S. Pat. No. 5,685,776A is a Hand-held electronic game device employing push buttons and other controls to manipulate game play and action on electronic displays, e.g., Liquid Crystal Display (LCD) or Light Emitting Diode (LED) display devices. The game devices have unique elongated, tubular forms in the shape of a stick. The electronic displays are integral with the unique tubular forms and generally centrally mounted therein. Various types of controls are employed at either or both ends of the game devices including, e.g., push buttons, pull switches, spring-loaded balls, flip switches, mouse controls, pointer balls, lever arms, or the like. Game concepts and operations are utilized based upon the particular control mechanisms employed as well as the unique physical shape and appearance of the devices.

A System and method for playing a virtual game by sensing physical movements having U.S. Pat. No. 2,013,019,672,7 issued to MQ Gaming LLC is a wireless input device for playing an interactive motionsensitive game using a wireless-compatible game console in which a virtual play environment is represented through one or more computer-animated visual, aural or tactile effects is provided wherein game play is conducted by moving, shaking, twisting, waving or pointing the input device in a particular manner. The input device can include motion-sensitive circuitry and/or command circuitry for generating control signals and/or an effects generator and associated control circuitry to enable the input device to selectively generate at least one visual, aural or tactile effect comprising sound, lighting or vibration. The input device can include a wireless transceiver for providing two-way wireless communication with the wireless-compatible game console. An optional lighting element emits a light signal or pattern that can be sensed by an external sensor or camera to interpret one or more movements or gestures made using the input device.

Another invention by Berman Robert bearing U.S. Pat. No. 5,108,115 is an Interactive game show and method for achieving interactive communication. The invention provides an interactive communication system whereby individuals are able to electronically select at least one possible outcome of a plurality of outcomes of a future event, individuals are able to participate in the outcome of that event and possibly share in a prize award associated with the event. In the preferred embodiment, individuals forming the home audience of a televized game show are able to electronically communicate a series of random numbers using their telephone to participate in possibly winning the prize awards of the show. In addition, both on-camera game participants and the studio audience also participate and have the ability to win prizes.

A tactile signal-producing vest worn while playing a video game bearing patent WO2,005,065,797 depicts a vest that is worn while playing a video game is in the shape of a bandoleer (10) and has a multiplicity of tactile signal producing elements thereon (80). The tactile-signal producing elements are located all around the player so the player will receive tactile signals from all directions and the signals can be received simultaneously so action in the video game will be accurately and realistically reproduced in the form of tactile signals.

Another US Patent depicts a Computerized game board bearing U.S. Pat. No. 5,853,327 issued to Covidien LP. It depicts a combination computer game and board game including a game board, a plurality of toy figures selectably position able by a player with respect to the game board and apparatus for automatically and non-discretely sensing the location of the toy figures relative to the game board and actuating an audio/visual display sequence in response thereto.

Another U.S. Pat. No. 2,006,017,575,3 application implies an electronic game board is provided for use in a DVD gaming system including a DVD player where DVD media incorporating commands and audio-visual content is accessed by the DVD player as part of game play. The electronic board may be used with play pieces and the board may be configured to determine the identity and location of a play piece on the electronic board and to wirelessly transmit location data to the DVD player. Play piece location information may be used by the DVD player to control game flow and select audio/visual content from the DVD media for display. The board may be configured to determine the location of finger contact on the board surface instead of play piece location. The board may also be configured to receive transmissions from the DVD player. The board may include command inputs such as buttons, switches or joysticks to be used as part of game play. The board may include a display for presenting information or pictures to players. The board may have overlays displaying different playing surfaces and playing spaces.

A U.S. Pat. No. 8,602,857B2 issued to TWEEDLETECH LLC is a board game system comprises one or more game objects, a processing device, a memory device and one or more cameras. Each of the game objects comprise a unique visual marker positioned on a top surface of the game object, wherein the unique visual marker comprises a series of concentric rings that represent data that uniquely identifies the game object. As a result, during the course of game play, the location and identification of the game objects are able to be determined by the processing device by analyzing images captured by the one or more cameras of the visual markers of the game objects on the game board. The processing device is able to compare the data of the visual markers to a table stored in the memory device that associates the data with a specific game object.

Another method and apparatus for educational games bearing U.S. Pat. No. 5,088,928A comprises a plurality of printed cards/boards, and a novel low-cost touch pad with interface cable to the personal computer game-port. When an educational game is played, the player responds to computer questions/words/graphic object by pressing the corresponding answer in the printed card/board, which is placed on top of the touch pad. This selection in terms of touched coordinates of the touch pad is sensed by the computer through the computer input/game port. Both computer generated sound and animation graphic pictures in terms of video games or others are used for either positive or negative feedback to the player. A variation of the same apparatus can be used for playing various computerized board games with a plurality of moving game pieces, and game boards by one or more players.

A talking board game patent issued to HASBRO INCORPORATED PAWTUCKET bearing U.S. Pat. No. 5,120,065A depicts a board and an electronic computer system providing speech information to the players, and cards, which can be read by the electronic computer system.

Another invention issued to Doyle Holly Thomis, Doyle Robert O, Wendl Thomis is the game disclosed where participants move their tokens, each representing a detective, over an indicia-carrying game board in pursuit of an imaginary thief whose location is not apparent on the board. The indicia on the board defines a multiplicity of locations of several types and possible paths of movement between locations in accordance with certain rules of the game. A value representing the location of the imaginary thief is held in a memory or storage register within a digital computing apparatus. The digital computing apparatus also includes a fixed table of information representing the various playing field locations, together with data representing the character of each location. The value representing the location of the thief is periodically changed, upon player initiation, in a manner determined by a random number generator but in a conformance with predetermined rules of movement. The digital computing apparatus also drives sound generating means to produce one of a plurality of characteristic sounds following each of the thief's moves. Each characteristic sound is associated with a particular type of location on the playing field so that the sounds constitute clues as to the thief's movement and location. The digital computing apparatus includes also a player operable means for initiating a capture and for designating a playing field location at which the capture is to take place. The processor determines whether the player has properly located the thief and generates corresponding audible sounds indicating success or failure.

The Charles; Eric patent having U.S. Pat. No. 5,451,050 presents an invention relates to apparatus for an interactive board game which closely resembles American football, together with the method of playing the game. A game board is included which is marked off with hash marks in a manner similar to American football, distinguished primarily by the presentation of a penalty zone in the center of the board separating two 50-yard fields of play. Game pieces, which closely resemble figurines in football dress, represent opposing teams which are moved in accordance with instructions on game cards or, alternatively, by the number on dice, and a missile, configured to have the general appearance of a football is used for field goals and extra points, such as by flicking the missile with one's finger from a predetermined position to project the missile through opposing goal posts.

None of the prior art work detailed above proposes a solution to the generalized problem of presenting a solution for children and teenagers, and especially children with special learning and developmental needs, an invention which combines technology with physical interaction and provides a progression in learning while in a play mode. Thus, through this invention it is possible to provide an interactive technology gaming platform and experience to children, and especially children with special need. The invention is an integrated learning/gaming system, which includes wearable clothing (with gaming designs) and a downloadable app that facilitates and scores interaction with the wearable gaming board.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole. [0041] An object of the present invention is to develop a product (an educational/learning system) having a process by which the game is played by a participant/child from the command or instructions received via an application installed on a mobile device, electronic tablet, smart watch or similar device.

A still further object of the present invention is to have a series of wearable game boards and designs that serve as the interactive platform for the game.

Another objective of the invention is to provide a simple technology for learning by using a daily wear article.

It is still another object of the present invention is to integrate a downloadable app that is used to direct the participant/child to complete the tasks or answer the questions that are on the game board, which is being worn by the other participant.

It is still another object of the present invention to develop a wearable game board that uses an app to create a fully interactive experience for the both participants.

Another object of the present invention is to develop a gaming system that allows a participant to wear clothing that has one of the game board designs printed on it for facilitate and encourage engagement and physical contact between the participants.

A still further object of the present invention is to provide a gaming system that allows a participant/child to use a tablet, smart phone or other mobile device with provisions for a downloaded app that instructs the participant/child to complete certain tasks on the wearable gaming board by interacting with the game board that is being worn.

It is another object of the present invention is to develop a process whereby a participant/child accrues learning ability via touching or interacting with the clothing (embodied with the game board) that results in developing and enhancing various basic learning skills and comprehension, e.g., finding certain elements or content; tracing various paths or designs; repeating works/letters/objects found on the designs; or combining various ideas and concepts found on the designs.

Another object of the present invention is to develop different game board designs with each having unique questions or tasks that have interfaces in the downloaded app.

Still another object of the present invention is to develop gaming boards having printed design on wearable clothing with its physical structure and components comprising of various sensors to further enhance the interactive and learning experience for the child.

Still another object of the present invention is the ability to store all game history and performance by each individual participant/child in the app database to allow parents/educators/therapists to create customized learning protocols for each individual child.

Another object of the proposed invention is to develop a game board system having interactive capability with the downloaded application brought forth via bio-mechanical means, through sensors or other wireless means, detected and recorded by the downloaded application installed in a mobile device, smart watch, or a tablet.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The mode of interaction of the game board system in its preferred embodiment is with the downloaded application is executed by a participant who is wearing one of the wearable game board designs, with another participant/child sitting, standing or somehow engaging the other participant and is prompted by the app to complete an action or task that requires the participant/child to interact with the wearable design/game board in some fashion. The person wearing the design confirms completion of the task (either satisfactory or unsatisfactory) and also records the result into the app via biomechanical or wireless means. The app scores the performance (based on the data entry by one of the participants) of the other participant/child for each question and maintains a database of all game scores and performance for each participant/child. The gaming system is designed to create an interactive experience between the two participants and stimulate physical contact and interaction.

The game board in its additional embodiment provides various games that consist of multiple skill levels and various sets of questions for each game board design. Once the user selects the game board design being worn, the game will start with the first question/task being prompted to the child to complete. The question is read and the participant/child then has to complete some actions, or answer a question, that involves interacting with the wearable design. Once completed the user enters the result into the app and the user is then prompted to complete the next question/task.

In a further embodiment of the present invention, the gaming board system may also allow interaction with mobile application through wireless and/or WiFi enabled sensors to provide automated feedback to the app to minimize or eliminate the manual data entry into the app.

The entire operation of the app related gaming board includes a participant most probably a child or teenager, physically engages with another participant who is wearing the design/game board. The integrated downloadable app, on the mobile or tablet, directs the participant/child to complete the tasks or answer the questions that are on the game board, which is being worn by the other participant. The game board provides various games that consist of multiple skill levels and various sets of questions for each game board design. The user selects the game board design being worn and the game starts with the first question/task by prompting the participant/child to complete.

The game in its further embodiment allows the question to be read and the participant/child completes the actions involving interacting with the wearable design. The user wearing the design game board enters the result into the app and the user is then prompted to complete the next question/task, which is then directed to the participant/child. The participant wearing the design confirms completion of the task by the other participant/child (as either satisfactory or unsatisfactory). The app scores the performance (based on the data entry by the adult) of the participant/child for each question and maintains a database of all game scores and performance for each participant/child.

The database of information and performance history contained within the app may be utilized by parents/educators/therapists to better construct learning programs for individual children and teenagers to focus on areas/skills with the greatest need for improvement and instruction.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

Image #1: Sample wearable game board with interactive designs;

Image #2 shows a exploded view of the present invention;

Image #3 is a perspective view of invention;

Image #4 is a full side view of our Invention;

Image #5 is a close full view of wearable game board with interactive designs;

Image #6 shows a front perspective view of invention;

Image #7 shows a complete perspective view of invention;

Image #8 shows the wearable game board with interactive designs;

Image #9 is another view of wearable game board with interactive designs;

Image #10 showing how the app allows interaction with various wearable designs;

Image #11 showing how the app allows for selection of various skill levels;

Image #12 showing how the app prompts questions for the participants through the game;

Image #13 showing how the app works for the participants through the game;

Image #14 showing how the app scores participants of the game;

Image #15 showing how the app stores historical performance, by participant;

Image #16 shows the app-directed interaction with one of the wearable designs;

Image #17 is another view of the app-directed interaction with one of the wearable designs;

1: An apparatus for use by two or more players for playing an educational or learning game printed on clothing and directed via an integrated app, which stimulates mental and physical playing between participants comprising of:
a gaming board/learning system design printed on clothing;
an interactive application which can be downloaded in any Android, window, iPad, laptop, smart watch or similar devices;
A message by the app prompting multiple questions to develop and enhance various basic learning skills and comprehension;
a bio-mechanical wireless, or Wi-Fi enabled means for entering the input to application to calculate the performance of participant;
a means for timing to calculate the required time to get the answer of question;
a said means to calculate the child score and show trend of progression in child development, learning and comprehension.

2: An app interacting with integrated wearable gaming board designs including, but not limited to, the following steps:
a downloaded application executed by a participant;
a participant wearing one of the wearable game board designs;
another participant/child physically interacting with the other participant;
a prompted message by the app to complete an action or task that requires the participant/child to physically interact with the wearable design/game board;
person wearing the design confirming the completion of the task via bio-mechanical, sensor; activation, wireless, or Wi-Fi enabled means;
app calculating and displaying the final result based on the data entry by one of the participants;
app providing feedback on performance and trending/scoring that performance over time—the game maintaining a database of all game scores and performance of participant/child.
An app having integrated wearable gaming board design consisting of following parameters:
games and learning systems consisting of multiple skill levels and various sets of questions for each game board design printed on clothing;
the game requiring the participants to both interact via the app and wearable design;
a hand or other physical movement and/or contact required to select the answer and/or complete a task.
